(19) United States
(12) Patent Application Publication
(10) Pub. No.: US 2014/0210719 A1
(43) Pub. Date: Jul. 31, 2014

(54) WIRELESS INPUT DEVICE

(71) Applicant: DEXIN CORPORATION, New Taipei City (TW)

(72) Inventor: YI-SHUN CHEN, NEW TAIPEI CITY (TW)

(73) Assignee: DEXIN CORPORATION, NEW TAIPEI CITY (TW)

(21) Appl. No.: 13/751,193

(22) Filed: Jan. 28, 2013

(51) Int. Cl. G06F 3/033

(52) U.S. Cl. CPC G06F 3/033
USPC 345/163

(57) ABSTRACT

The wireless input device comprises a mouse body, a radio receiver and a transmission line. The mouse body provides a charging battery and a first connector, the charging battery is sited in the mouse body, the first connector is electrically connected with the charging battery; the radio receiver has a plug connector and a second connector, the second connector is electrically connected with the plug connector; and the transmission line has a first transmission connector and a second transmission connector; wherein the radio receiver receives wirelessly an input signal outputted from the mouse body, and the input signal is transferred to an electronic apparatus connected with the plug connector; the radio receiver receives charging power through the plug connector supplied from the electronic apparatus, and transfers the charging power to the mouse body via the transmission line, so as to charge the charging battery in the mouse body.

### BACKGROUND OF THE INVENTION

1. Field of the Invention

The present invention relates to a wireless input device; in particular, to a wireless input device capable of being recharged.

2. Description of Related Art

The wireless input device is such as a wireless mouse. The wireless mouse has become a necessary device in one of the computer periphery, and, similar to a keyboard, the wireless mouse provides users with easy operation and execution of the computer program.

The connection between a wireless input device and a computer is not confined to a cable, thus the wireless input device could be more convenient for the operation and execution of the computer program. However, the wireless input device is usually supplied with power through battery. When the battery power is exhausted, the user should replace the battery of the wireless input device so as to extend the wireless operation function of the wireless input device.

Furthermore, when the power of battery in a wireless input device is exhausted, the wireless input device should be charged through transmission lines or charging sockets having charging function. If the wireless input device is connected with an electronic apparatus through a transmission line having charging function, then the transmission line having charging function will occupy additionally an output connector of the electronic apparatus, thus two output connectors of the electronic apparatus are occupied, thereby the operation inconvenience of the wireless input device is reduced.

### SUMMARY OF THE INVENTION

The object of the present invention provides a wireless input device. When the power of a charging battery in the wireless input device is exhausted, the second connector of a radio receiver could be connected with a transmission line, thereby the charging power is transferred via the transmission line to the mouse body, and the radio receiver will not additionally occupy the output connector of the electronic apparatus, therefore the convenience for operating the wireless input device is enhanced.

The invention provides a wireless input device, comprising a mouse body, a radio receiver and a transmission line. The mouse body comprises a charging battery and a first connector, the charging battery is set in the mouse body, and the first connector is electrically connected with the charging battery; the radio receiver comprises a plug connector and a second connector, and the second connector is electrically connected to the plug connector; and the transmission line comprises a first transmission connector and a second transmission connector, the first transmission connector is electrically connected to the second transmission connector, the first transmission connector is connected to the first connector, and the second transmission connector is connected to the second connector; wherein the radio receiver receives wirelessly an input signal outputted from the mouse body, and the input signal is transferred to an electronic apparatus connected with the plug connector; and the radio receiver receives a charging power supplied from the electronic apparatus through the plug connecter, and the charging power is transferred to the mouse body via the transmission line so as to charge the charging battery in the mouse body.

In order to achieve the aforementioned objects, according to an embodiment of the present invention, the second connector above-mentioned comprises two power terminals.

According to an embodiment of the present invention, the second connector above-mentioned comprises two power terminals and two data terminals.

According to an embodiment of the present invention, the plug connector above-mentioned conforms the transmission specification of universal serial buses.

According to an embodiment of the present invention, the mouse body above-mentioned comprises a mode setting unit, which controls the mode to operate in a wireless transmission mode or a wired transmission mode. The mouse body outputs the input signal to the radio receiver wirelessly in the wireless transmission mode, and outputs the input signal to the radio receiver by a transmission line in the wired transmission mode.

According to an embodiment of the present invention, the mode setting unit above-mentioned is a detection circuit, which detects the connection status of the transmission line between the first transmission connector and the first connector, the mouse body operates in the wired transmission mode when the detection circuit detects that the first transmission connector is connected with the first connector, and the mouse body operates in the wireless transmission mode when the detection circuit detects that the first transmission connector is not connected with the first connector.

According to an embodiment of the present invention, the mode setting unit above-mentioned comprises a switch circuit.

According to an embodiment of the present invention, the second connector and the second transmission connector above-mentioned respectively comprise corresponding magnetic elements, so that the second connector attracts the second transmission connector magnetically.

According to an embodiment of the present invention, the second connector and the second transmission connector above-mentioned respectively comprise corresponding fastening elements, so that the second connector is fastened with the second transmission connector inseparably.

According to an embodiment of the present invention, the mouse body comprises a charging circuit, which is connected between the first connect and the charging battery.

In summary, a wireless input device of the present invention could be connected with the transmission line through the second connector of the radio receiver, so that the charging power could be transferred to a mouse body through the transmission line, and the radio receiver doesn't occupy additionally the output connector of the electronic apparatus, therefore the convenience for operating the wireless input device is enhanced.

In order to further understand the present invention, the following embodiments are provided along with illustrations to facilitate the disclosure of the present invention.

### BRIEF DESCRIPTION OF THE DRAWINGS

FIG. 1 shows a perspective diagram of a wireless input device according to an embodiment of the present invention;

FIG. 2 shows a perspective diagram of the wireless transmission mode for the wireless input device according to an embodiment of the present invention;

FIG. 3 shows a perspective diagram of the wired transmission mode for the wireless input device according to an embodiment of the present invention;

FIG. 4 shows a perspective diagram of the wireless input device according to another embodiment of the present invention;

FIG. 5 shows a perspective diagram of the wireless input device according to another embodiment of the present invention;

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings, and they are not used to limit the present invention.

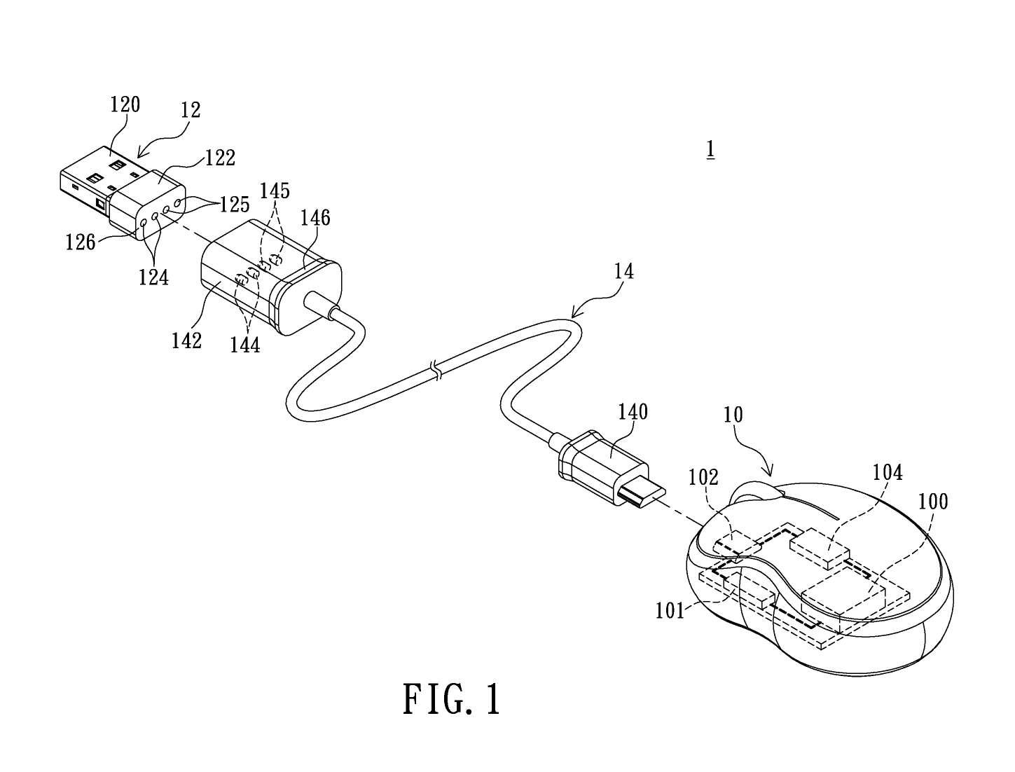

FIG. 1 illustrates a perspective diagram of a wireless input device according to the first embodiment of the present invention. The present invention provides a wireless input device 1, which comprises a mouse body 10, a radio receiver 12, and a transmission line 14. The wireless input device is such as a wireless mouse. The power could be transferred between the radio receiver 12 and the mouse body 10 through the transmission line 14. Certainly, the mouse body 10 comprises a wireless transceiver (not shown in the figure), which transfers wirelessly the input signal such as a pointing or clicking signal etc. to the radio receiver 12, and it is not described here.

In this embodiment, the mouse body 10 comprises a charging battery 100, a first connector 102 and a mode setting unit 104 and the charging battery 100 is set in mouse body 10. The first connector 102 is connected electrically with the charging battery 100. In practice, the first connector is such as the universal serial bus (USB), Mini universal serial bus (Mini USB), Micro universal serial bus (Micro USB) or another device that could transmit signal and current simultaneously. The type of the first connector 102 is not limited in the embodiment. And according to FIG. 1, certainly the first connector 102 could be set at the front end or any position of the mouse body 10. The position where the first connector 102 is set at the mouse body 10 is also not limited in the embodiment.

The charging battery 100 may be such as the NiH battery, NiCd battery or Li battery. When the charging battery 100 exhausts the power, it could be charged for reuse. The type of the charging battery 100 is not limited in the embodiment. In practice, the mouse body 10 comprises a charging circuit 101, which is connected between the first connector 102 and the charging battery 100, and the power is transferred to the charging battery 100 through the first connector 102.

In more detail, the mouse body 10 comprises a mode setting unit 104, the mode setting unit 104 controls the mouse body 10 to operate in the wireless or wired transmission mode, wherein the mouse body 10 outputs the input signal to the radio receiver 12 wirelessly in the wireless transmission mode, and outputs the input signal to the radio receiver 12 through the transmission line 14 in the wired transmission mode.

In this embodiment of the present invention, the mode setting unit 104 is a detection circuit, which detects the connection status of the transmission line 14 between the first transmission connector 140 and the first connector 102, the mouse body 10 operates in the wired transmission mode when the detection circuit 104 detects that the first transmission connector 140 and the first connector 104 are connected, and the mouse body 10 operates in the wireless transmission mode when the detection circuit detects that the first transmission connector 140 and the first connector 104 are not connected. In other embodiment, the mode setting unit 104 could be implemented with a switch circuit; the type of the mode setting unit 104 is not limited in the embodiment.

The radio receiver 12 comprises a plug connector 120 and a second connector 122; the second connector 122 is electrically connected to the plug connector 120. In practice, the plug connector 120 may be such as the universal serial bus (USB), Mini universal serial bus (Mini USB), Micro universal serial bus (Micro USB) or another device that could transmit signal and current simultaneously. The type of the plug connector 120 is not limited in the embodiment. The plug connector 120 could be inserted in an electronic apparatus (not shown) such as computer, iPad, notebook or digital home appliances. The types and insertion styles of the plug connector 120 and the electronic apparatus (not shown) are not limited in the embodiment.

For example, the radio receiver 12 could use the technology of radio frequency or blue tooth, etc. The plug connector 120 of the radio receiver 12 is inserted to the electronic apparatus (not shown), therefore wireless signals could be transmitted between the radio receiver 12 and the mouse body 10 through the wireless technology of radio frequency or blue tooth, etc. Furthermore, the end, relative to plug connector 120, of the radio receiver 12 is the second connector 122. The second connector 122 comprises two power terminals 124 and two data terminals 125. In other embodiment, the second connector 122 could comprise two or more than two power terminals 124 and several data terminals 125. The amount of power terminals 124 and data terminals 125 of the second connector 122 could be designed freely by a person having ordinary skill in the related technical field.

In detail, except the wireless radio frequency or wireless blue tooth function, the radio receiver 12 also comprises a second connector 122, and the two power terminals 124 of the second connector 122 are used to transmit the charging power, therefore the radio receiver 12 could transmit the charging power of the electronic apparatus (not shown); the two data terminals 125 of the second connector 122 are used to transmit an input signal, therefore the radio receiver 12 could receive the input signal such as a pointing or clicking signal etc. of the mouse body 10.

The transmission line 14 includes a first transmission connector 140 and a second transmission connector 142, wherein the first transmission connector 140 is electrically connected with the second transmission connector 142, the first transmission connector 140 is connected to the first connector 102, and the second transmission connector 142 is connected to the second connector 122. In practice, the first transmission connector 140 is such as the universal serial bus (USB), Mini universal serial bus (Mini USB), Micro universal serial bus (Micro USB) or another device that could transmit signal and current simultaneously. The type of the first transmission connector 140 is not limited in the embodiment.

In detail, the first transmission connector 140 will be changed according to the type of the first connector 102. For example, if the first connector 102 is the Mini universal serial bus (Mini USB), then the first transmission connector 140 also has a corresponding Mini Universal Serial Bus (Mini USB), thereby the first transmission connector 140 can be connected to the first connector 102. The types and connection styles of the first transmission connector 140 and the first connector 102 are not limited in the embodiment.

Likewise, the second transmission connector 142 will be changed according to the type of the second connector 122. For example, if the second connector 122 includes two data terminals 125 and two power terminals 124, then the second transmission connector 142 also has correspondingly two data terminals 145 and two power terminals 144, thereby the second transmission connector 142 could be connected to the second connector 122. The types and connection styles of the second transmission connector 142 and second connector 122 are not limited in the embodiment.

It is worth mentioning that the second connector 122 and the second transmission connector 142 are provided correspondingly with magnetic elements 126, 146 separately, so that the second connector 122 can attract the second transmission connector 142 magnetically. In practice, the magnetic elements 126, 146 may be magnets or metal articles with a property of attraction with magnets, thereby both the second connector 122 and the second transmission connector 142 can attract each other magnetically, such that the second connector 122 and the second transmission connector 142 can be connected together. The types of the magnetic elements 126,146 or the positions where they are arranged in the second transmission connector 142 and the second connector 122 are not limited in the embodiment.

Based on the above, the radio receiver 12 receives wirelessly an input signal outputted from the mouse body 10, and the input signal is transferred to an electronic apparatus (not shown) connected with the plug connector 120; the radio receiver 12 receives through the plug connector 120 a charging power supplied from the electronic apparatus (not shown) and transfers the charging power to the mouse body 10 via the transmission line 14, so as to charge the charging battery 100 in the mouse body 10.

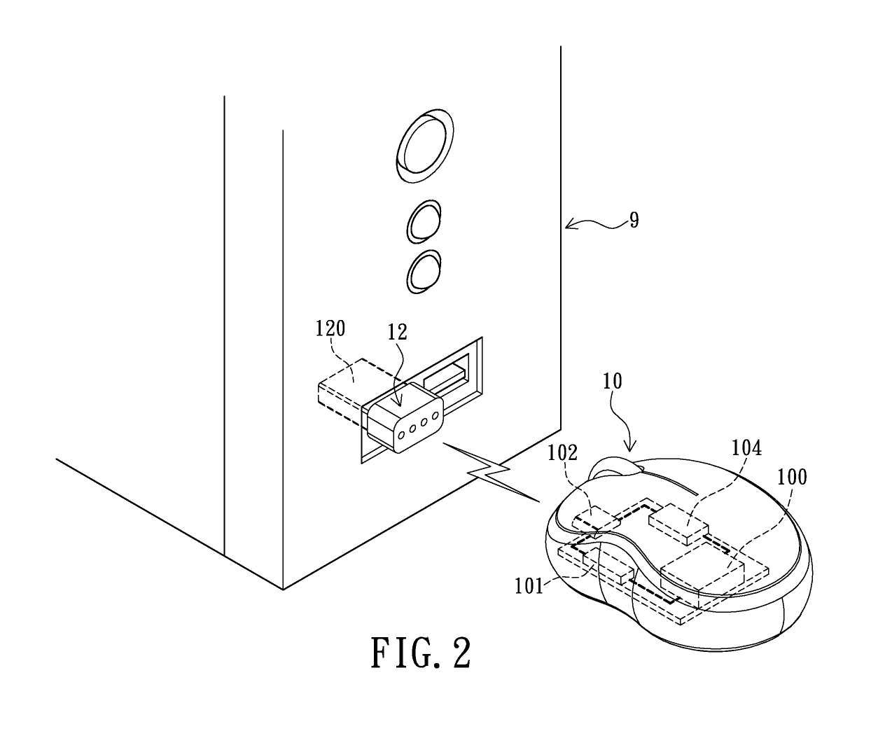

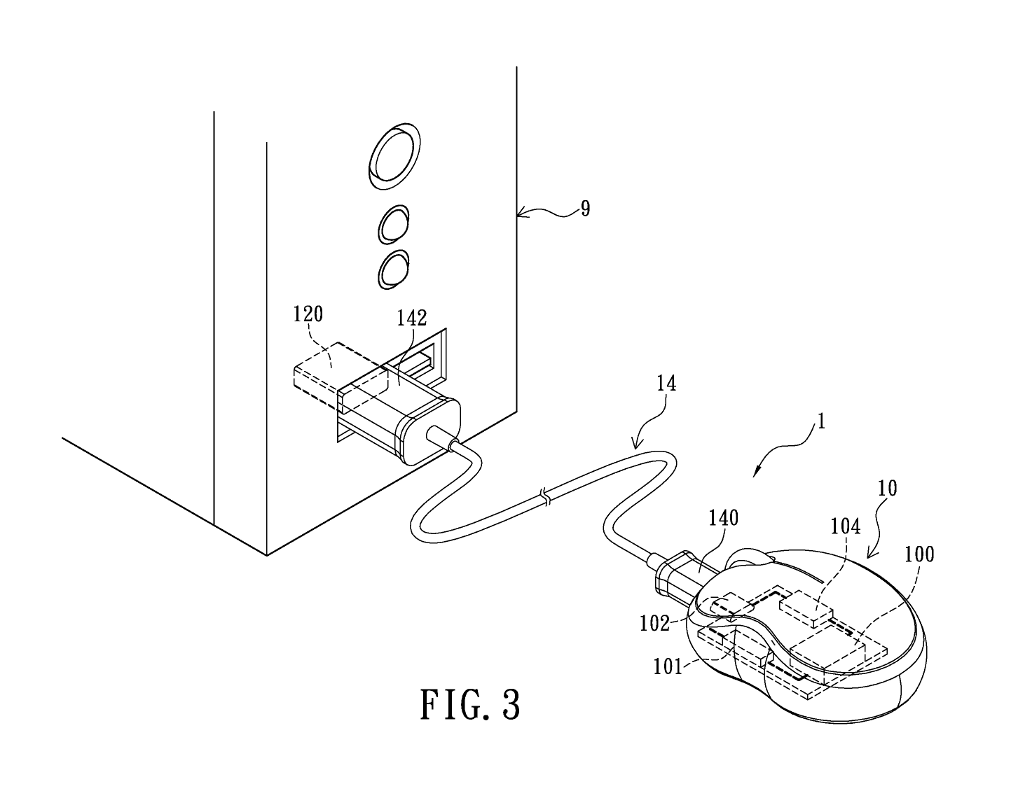

Then, the operation for the wireless input device 1 is further described. FIG. 2 is a wireless architecture diagram of the wireless input device according to one embodiment in FIG. 1. And FIG. 3 is a wired architecture diagram of the wireless input device according to one embodiment in FIG. 1. Please refer to FIG. 2 and FIG. 3. FIG. 2 shows that the plug connector 120 of radio receiver 12 is inserted to the electronic apparatus 9, the radio receiver 12 receives wirelessly the input signal outputted from the mouse body 10, and the input signal is transferred to the electronic apparatus 9 connected with the plug connector 120. Certainly, the mouse body 10 maintains that the input signal is transferred wirelessly to the radio receiver 12 by means of electrical amount of the charging battery 100. The wireless transmission between the mouse body 10 and the radio receiver 12 will not be maintained if the charging battery 100 runs out of power.

Next, FIG. 3 shows that the transmission line 14 is connected between the radio receiver 12 and the mouse body 10, thereby the radio receiver 12 receives via the plug connector 120 the charging power supplied from the electronic apparatus 9 and transfers the charging power to the mouse body 10 via the transmission line 14, so as to charge the charging battery 100 in the mouse body 10. Certainly, the detection circuit of the mouse body 10 could detect the status of wired transmission mode when the first transmission connector 140 and the first connector 102 are connected, thereby the radio receiver 12 receives the input signal outputted from the mouse body 10 via the transfer line 14, and the input signal is transferred to the electronic apparatus 9 connected with the plug connector 120.

From the description above, the wireless input device 1 could perform charging and transmit a pointing or clicking signal to the electronic apparatus 9 simultaneously, thereby the convenience for the operation of the wireless input device 1 is enhanced, and the operation type of the wireless input device 1 is not limited in this embodiment.

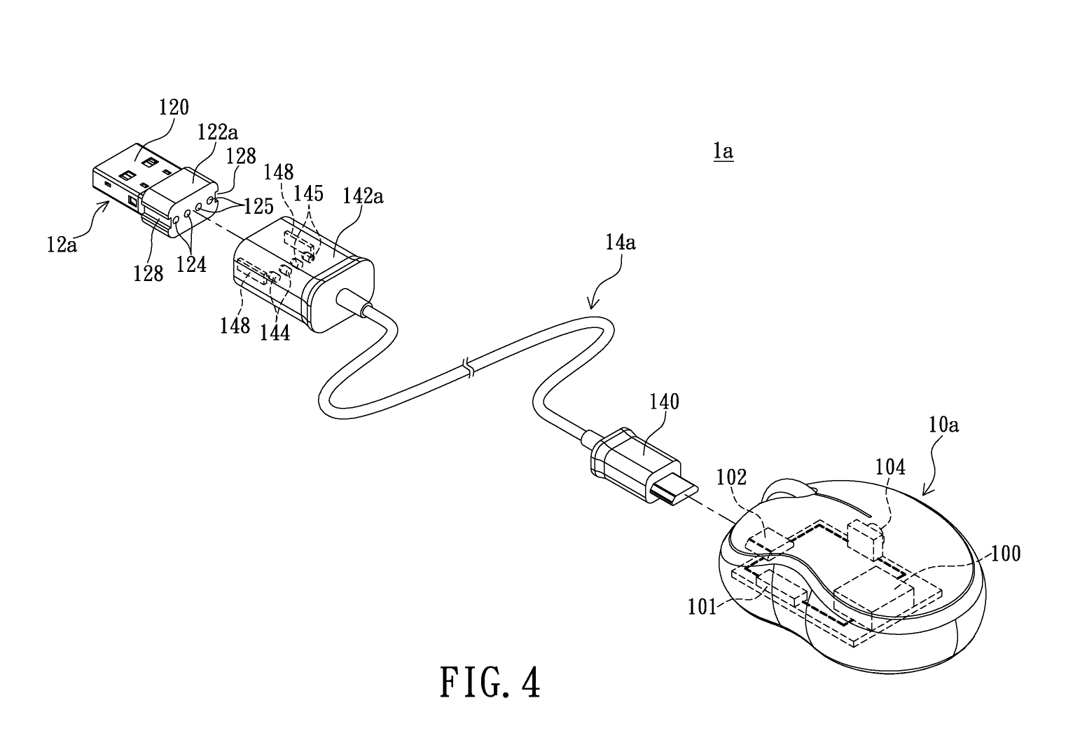

In the second embodiment, the wireless input device 1 could be implemented in different ways. FIG. 4 shows a wireless input device schematic diagram of another embodiment. The wireless input device 1a in FIG. 4 and the wireless input device 1 in FIG. 1 are similar in the architecture, and in the following the same elements are represented by the same reference numerals. The wireless input devices 1a, 1 are different in that: the mode setting unit 104 in the mouse body 10 of the wireless input device 1a is a switch circuit. The switch circuit is such as a key switch circuit or a sliding switch circuit, which is used for switching the wireless transmission mode or the wired transmission mode. The type of the switch circuit is not limited in this embodiment.

For example, the mouse body 10a is connected to the radio receiver 12a through the transmission line 14a, the radio receiver 12a receives via the plug connector 120 the charging power supplied from the electronic apparatus (not shown) and transfers the charging power to the mouse body 10a via the transmission line 14a, so as to charge the charging battery 100 in the mouse body 10a, wherein the side of the mouse body 10a is provided with a key switch, which is available for the users to press so as to start the switching function of the mouse body 10a, and if the switch circuit is switched to the wireless transmission mode, the wireless receiver 12a could receive wirelessly the input signal outputted from the mouse body 10a, and transmits the input signal to the electronic apparatus (not shown) connected with the plug connector 120. In other words, the wireless input device 1a transfers the charging power through the transmission line 14a, and transfers wirelessly the input signal by means of the radio receiver 12a and the wireless transceiver (not shown) of the mouse body 10a.

If the switch circuit is switched to the wired transmission mode, the wireless receiver 12a could receive through the transmission line 14a the input signal outputted from the mouse body 10a, and transmits the input signal to the electronic apparatus (not shown) connected with the plug connector 120. In other words, the wireless input device 1a transfers the input signal and the charging power through the transmission line 14a. The operation type for charging and transferring signal of the wireless input device 1a is not limited in this embodiment.

It is worth mentioning that the second connector 122a and the second transmission connector 142a are provided correspondingly with fastening elements 128 separately, so that the second connector 122a is fastened to the second transmission connector 142a as shown in FIG. 4. The fastening element 128 is such as a bayonet, fastener or slot, etc. The type of the fastening element 128 is not limited in this embodiment.

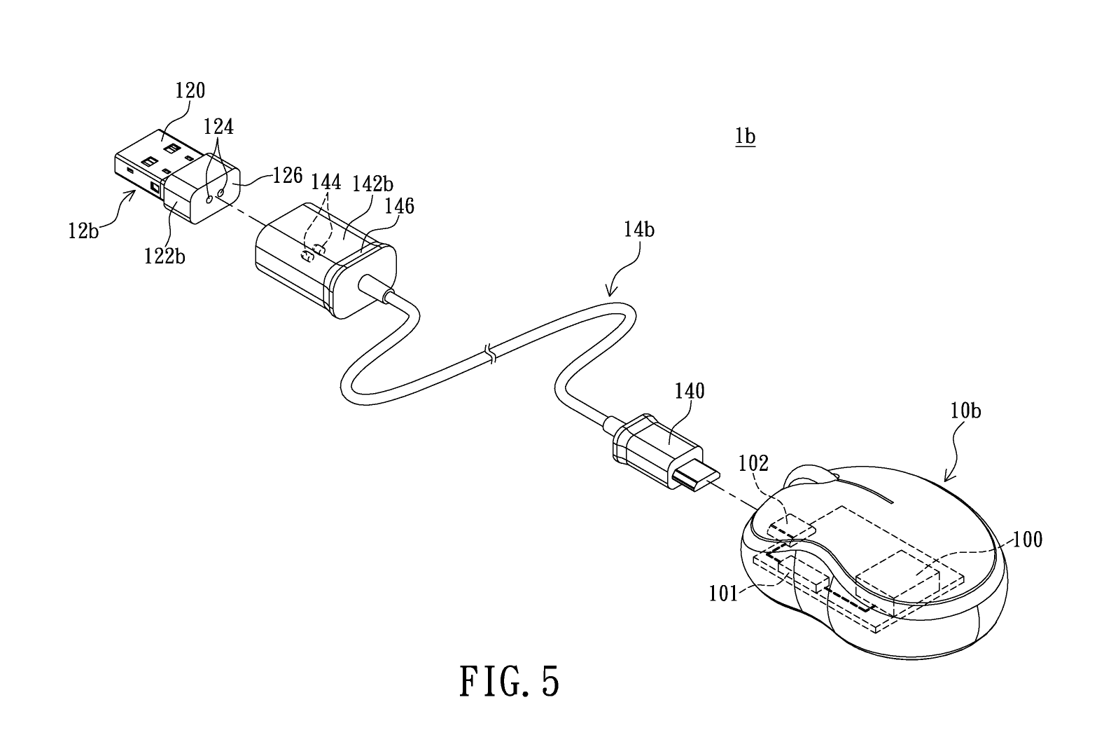

The third embodiment of the present invention is shown in FIG. 5, which shows a wireless input device of another embodiment. Please refer to FIG. 5. The wireless input device 1b in this embodiment is similar to the wireless input device 1 of the above embodiment, for example, the wireless input device 1b also could transmit the charging power through the transmission line 14b. However, there exists still difference between the wireless input device 1b and 1 in that: the mouse body 10b does not include the mode setting unit, thereby the radio receiver 12b receives wirelessly the input signal outputted from the mouse body 10b and transmits the input signal to the electronic apparatus (not shown) connected with the plug connector 120. In other words, the wireless input device 1b transfers the charging power through the transmission line 14b, and transfers wirelessly the input signal by means of the radio receiver 12b and the wireless transceiver (not shown) of the mouse body 10b.

In addition, the second connector 122b includes two power terminals 124, and certainly the second transmission connector 142b also has correspondingly two power terminals 144b, the remaining part is the same and will not be repeated here.

In summary, a wireless input device is used in the present invention, when the electrical amount in the charging battery of the wireless input device is exhausted, the second connector of the radio receiver could be connected with the transmission line, so that the charging power could be transferred to a mouse body by the transmission line, and the radio receiver does not occupy additionally the output connector of an electronic apparatus. Furthermore, the wireless input device includes a mode setting unit, thereby the mouse body is set to operate in a wireless transmission mode or a wired transmission mode. The mouse body outputs wirelessly the input signal to the radio receiver in the wireless transmission mode, and outputs the input signal to the radio receiver by a transmission line in the wired transmission mode. Therefore, convenience for operating the wireless input device is enhanced.

The descriptions illustrated supra set forth simply the preferred embodiment of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A wireless input device, comprising:
a mouse body, provided with a charging battery and a first connector, wherein the charging battery is sited in the mouse body, and the first connector is electrically connected with the charging battery;
a radio receiver, having a plug connector and a second connector, wherein the second connector is electrically connected with the plug connector; and
a transmission line, having a first transmission connector and a second transmission connector, wherein the first transmission connector is electrically connected with the second transmission connector, the first transmission connector is connected with the first connector, and the second transmission connector is connected with the second connector;
wherein the radio receiver receives wirelessly an input signal outputted from the mouse body, and the input signal is transferred to an electronic apparatus connected with the plug connector; and the radio receiver receives a charging power supplied from the electronic apparatus through the plug connecter, and the charging power is transferred to the mouse body via the transmission line, so as to charge the charging battery in the mouse body.

2. The wireless input device according to claim 1, wherein the second connector comprises two power terminals.

3. The wireless input device according to claim 1, wherein the second connector comprises two power terminals and two data terminals.

4. The wireless input device according to claim 1, wherein the plug connector conforms the transmission specification of a universal serial bus.

5. The wireless input device according to claim 3, wherein the mouse body comprises a mode setting unit, which sets the mouse body to operate in a wireless transmission mode or a wired transmission mode, wherein the mouse body transfers wirelessly the input signal to the radio receiver in the wireless transmission mode, and transfers the input signal to the radio receiver through the transmission line in the wired transmission mode.

6. The wireless input device according to claim 5, wherein the mode setting unit is a detection circuit, which detects the connection status of the transmission line between the first transmission connector and the first connector, the mouse body operates in the wired transmission mode when the detection circuit detects that the first transmission connector and the first connector are connected, and operates in the wireless transmission mode when the detection circuit detects that the first transmission connector and the first connector are not connected.

7. The wireless input device according to claim 5, wherein the mode setting unit comprises a switch unit.

8. The wireless input device according to claim 1, wherein the second connector and the second transmission connector are respectively provided with corresponding magnetic elements, so that the second connector attracts the second transmission connector magnetically.

9. The wireless input device according to claim 1, wherein the second connector and the second transmission connector are respectively provided with corresponding fastening elements, so that the second connector is fastened with the second transmission connector.

10. The wireless input device according to claim 1, wherein the mouse body comprises a charging circuit, which is connected between the first connector and the charging battery.
